(19) United States
(12) Patent Application Publication
(10) Pub. No.: US 2007/0280064 A1
(43) Pub. Date: Dec. 6, 2007

(54) OPTICAL DISK DEVICE

(76) Inventor: KOUJI FUJITA, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/751,656

(22) Filed: May 22, 2007

(30) Foreign Application Priority Data
Jun. 6, 2006 (JP) 2006-156757

(51) Int. Cl. G11B 7/00

(52) U.S. Cl. 369/44.29; 369/44.32

(57) ABSTRACT

An optical disk servo device capable of correcting spherical aberration occurring by thickness errors of a cover layer of an optical disk or disc while avoiding risks of influence by vibrations and shocks or else is disclosed. The device includes an optical head unit for writing or reading information to or from the optical disk, a tracking-servo unit, a lens for correction of spherical aberration, and a lens position detector for detecting a position change amount or displacement of the lens and for generating at its output a lens position detection signal, which is then subjected to negative feedback to the tracking-servo unit.

### INCORPORATION BY REFERENCE

The present application claims priority from Japanese application JP2006-156757 filed on Jun. 6, 2006, the content of which is hereby incorporated by reference into this application.

### BACKGROUND OF THE INVENTION

1. Field of the Invention

The present invention relates to an optical disk device which performs correction of spherical aberration, inter alia, of an optical head to be built in optical disk drives.

2. Description of the Related Art

JP-A-5-266511 discloses therein a technique for driving an aberration correcting lens. In the technique as taught thereby, the aberration correcting lens is moved by a motor-driven rotation mechanism in a way corresponding to a substrate thickness being recorded on a disk or a substrate thickness which is measured by a measurement device that is provided in a recording/reproduction apparatus. However, the Japanese bulletin is silent about a control procedure for avoiding vibrations and physical shocks applied to the aberration correcting lens.

### SUMMARY OF THE INVENTION

In recent years, with increases in image quality of HD video data and full-scale implementation of digital broadcasting, the need for storage devices with large capacities is becoming higher. Typical examples of large-capacity optical disks are digital versatile disks (DVDs) and Blu-ray™ discs (BDs). DVDs are 650 μm in laser wavelength, 0.6 in numerical aperture (NA) of objective lens, 0.6 mm in transparent resin substrate thickness, and 4.7 GB in recording capacity per optical disk (per layer). For the purpose of achieving further increased storage capacities, advanced DVDs are developed of the type having a two-layer structure with a couple of 0.6 mm-thick transparent resin substrates bonded together to offer the recording capacity of 8.5 GB.

On the other hand, in order to achieve mass-storage capacity much larger than DVDs, BDs are designed so that the laser wavelength is set to 405 μm, the NA of objective lens is 0.85, the transparent resin substrate thickness is 0.1 mm, and the per-disk (per-layer) recording capacity is 23.3 GB. BDs are also capable of realizing further increased storage capacities by employing multilayer structures in a similar way to DVDs.

In this way, BDs are such that the recording wavelength is made shorter in order to provide increased recording capacity, which is greater than that of DVDS. Accordingly, a laser beam falling onto an optical disk is focused to form thereon a beam spot with its diameter smaller than that for DVDs. To this end, the NA value of objective lens for BDs is designed to be larger than that for DVDs. Such increase in NA value would result in the position of a focused laser beam spot on the disk surface becoming different between the optical axis center of a laser spot and the outer circumference, which is called the aberration. Thus, the influence as to loss of the spot focusability becomes more significant.

The aberration includes many kinds of aberrations, such as spherical aberration, coma aberration, nonpoint aberration or “astigmatism” and others. The spherical aberration is occurrable due to the presence of manufacturing deviations of the thickness of a transparent substrate for protection of an optical recording medium and deviations of optical components. The coma aberration occurs due to unwanted warping of optical recording media, deviations of optical components, adjustment deviance or the like. The astigmatism takes place due to accuracy mismatching of optical components, assembly errors, deviations and tilting of the optical axis or the like. Once the laser beam on an optical recording medium increases in diameter due to these aberrations, it is no longer possible to record correct information on the optical recording medium. This makes it impossible to correctly reproduce the information recorded.

Incidentally, techniques for correcting the spherical aberration occurring due to a change in thickness of optical disk substrate include a method for moving an aberration correcting lens by a motor rotation mechanism or the use of an aberration correcting mechanism which moves the aberration correcting lens by means of the vibration of a piezoelectric element. Additionally, in order to downsize the aberration correction mechanism, it becomes inevitable to employ the method using a piezoelectric element(s). However, remedies for displacement and aberration deviation occurring due to vibrations and/or shocks in the above-noted spherical aberration drive mechanism are not taken into consideration in the prior art, including JP-A-5-266511.

It is therefore an object of this invention to provide an optical disk servo control apparatus capable of stably performing the correction of spherical aberration for maintaining the required recording/reproduction performances even in cases where vibrations and/or shocks take place.

The foregoing object is achievable by the invention as recited in appended claims.

In accordance with the invention, even where vibrations and/or shocks are applied in the process of performing recording and playback information to and from an optical disk, it is possible to retain stable recording/playback performances, thereby enabling achievement of enhanced recording reliability.

### BRIEF DESCRIPTION OF THE DRAWINGS

FIG. 1 is a diagram showing a first embodiment.

FIG. 2 is a diagram showing an aberration correcting lens drive mechanism.

FIG. 3 is a diagram for explanation of the influence to a beam spot.

### DETAILED DESCRIPTION OF THE EMBODIMENTS

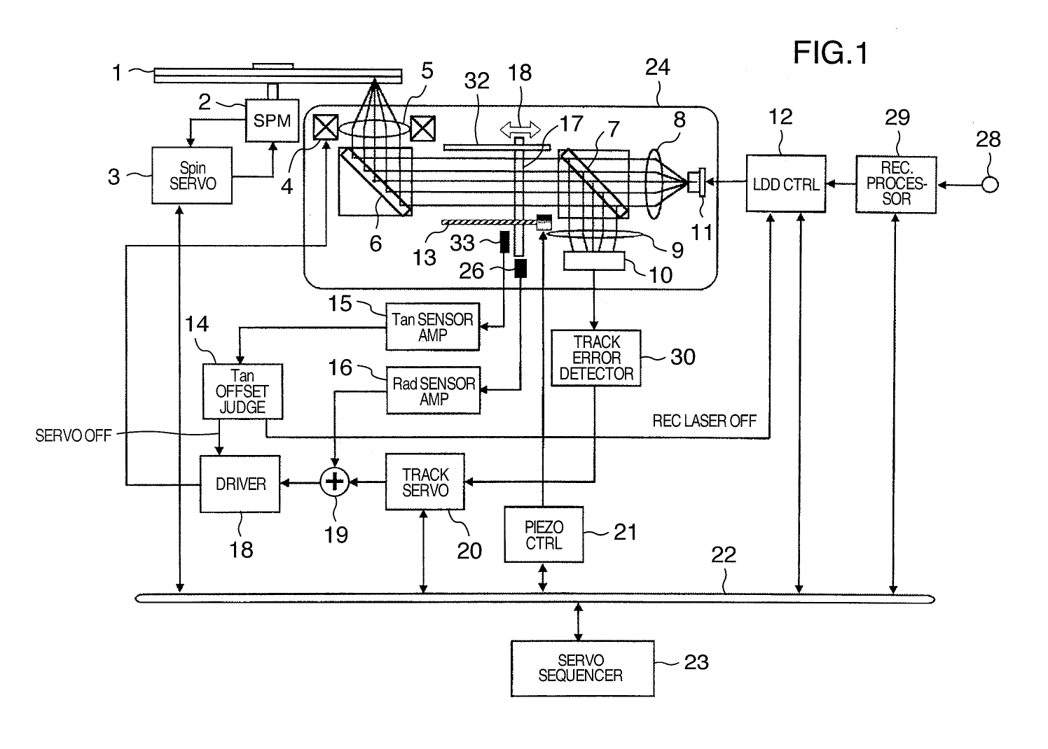

Embodiments of this invention will be described with reference to the accompanying drawings. The description below is illustrative of this invention and is not to be construed as limiting the apparatus or device of the invention. FIG. 1 shows an optical disk device having an aberration correction means.

Reference numeral 1 designates an optical disk or disc; 2 denotes a spindle motor; 3 indicates a spindle servo unit; 4 is a traffic actuator; 5, a convex lens; 6, polarization mirror; 7, beam splitter; 8, collimate lens; 9, detection lens; 10, light-receiving unit; 11, laser; 12, laser driver; 29, recording processing unit; 28, input terminal; 15, tangential sensor amplifier (“Tan” sensor amp); 16, radial sensor amplifier (“Rad” sensor amp); 30, tracking error detector; 18, driver unit; 19, adder; 20, tracking servo unit; 21, control unit with a built-in piezoelectric element, also called the piezoelectric controller; 22, signal line bus; 23, servo sequencer unit; 24, pickup unit; 33, Tan displacement sensor (alternatively, Tan acceleration sensor); 26, Rad displacement sensor (or Rad acceleration sensor).

To rotate the optical disk 1, the spindle motor 2 performs feedback of an angular rotation speed signal of the spindle motor to the spin servo unit 3, thereby to perform rotation control at a constant rotation speed.

An aberration correction mechanism is generally made up of a friction guide 13, an aberration correcting lens 17, a piezoelectric vibration unit 31, a parallel guide 32, a displacement detector unit (Rad displacement sensor) 26 which detects a position deviation amount of the lens with a laser spot on the optical disk being displaced in a radial direction due to displacement of the lens, i.e., a position deviation in a direction at right angles to an optical axis of the aberration correcting lens 17, and a displacement detector unit (Tan displacement sensor) 33 which detects a position deviation amount of the lens with the on-disk laser spot being displaced in a tangential direction due to displacement of the lens, i.e., displacement in a direction perpendicular to the optical axis of aberration correcting lens 17. (In the description below, the displacement direction of the lens with a laser spot on the optical disk being displaced in the radial direction due to the displacement of the lens, which displacement is a position deviation in a direction extending at right angles to the optical axis of aberration correcting lens 17, will be referred to as the first displacement direction whereas the displacement direction of the lens with the on-disk laser spot being displaced in the tangential direction due to the displacement of the lens, which displacement is a position deviation in a direction at right angles to the optical axis of aberration correcting lens 17, will be referred to as the second displacement direction.)

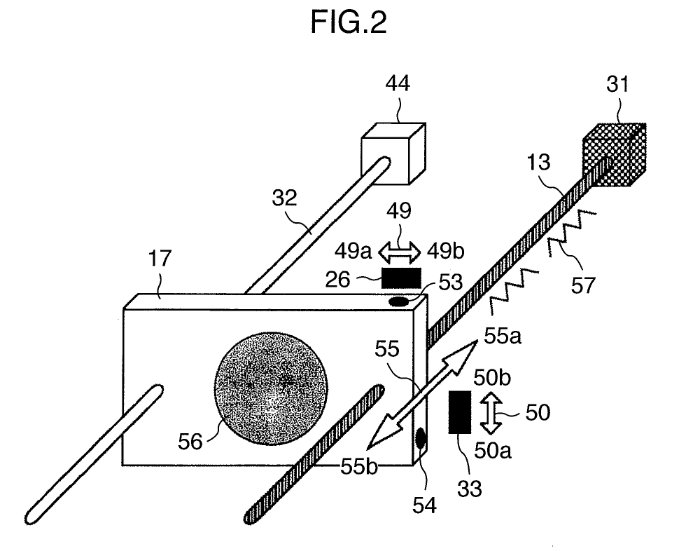

The aberration correcting lens 17 is a mechanism that moves back and forth in the optical axis direction (indicated by arrows 55a and 55b in FIG. 2), and uses the piezoelectric vibrator 31 and friction guide 13 for this movement purpose. To drive the aberration correcting lens 17 in the optical axis direction, instruction information as to a moving direction and moving speed of the aberration correcting lens 17 is transmitted from the servo sequencer 23 while the piezoelectric control unit 21 sends at its output a vibration drive signal to the piezoelectric vibrator 31. By varying the frequency of such vibration drive signal and the duty cycle of a rectangular or square wave, feed-forward vibration or return vibration is transferred to the friction guide 13, thereby driving the aberration correcting lens 17 in the optical axis direction. The drive method of the aberration correcting lens 17 should not be interpreted to be limited only to the above-noted piezoelectric vibration technique and may alternatively be modified to employ any other driving methods using rotation motors, linear motors, electromagnetic conversion schemes or else, which are also included in the scope of this invention. The movement mechanism of the aberration correcting lens 17 becomes a mechanism which permits the movable lens to move in the optical axis direction only.

Here, one example of the drive mechanism of aberration correcting lens 17 is shown in FIG. 2. The explanation below is devoted to an illustrative embodiment of this invention and is not to be construed as limiting the invention. The aberration correcting lens 17 constitutes a lens 56 within a lens frame. The aberration correcting lens 17 is movable forward and backward along the optical axis direction as indicated by arrows 55a and 55b. A drive source permits the piezoelectric vibrator 31 to produce feed vibration for vibrating the friction guide 13, resulting in the aberration correcting lens 17 being vibrated by such vibration. A detector configuration for detecting a position deviation amount in the first displacement direction (arrow 49a, 49b) of the aberration correcting lens 17 is made up of a magnet 53 that is bonded to a side wall of the aberration correcting lens 17 and a non-contact displacement sensor of a hall sensor for use as the Rad displacement sensor 26. Similarly, a detector module for detecting a position deviation amount in the second displacement direction (arrow 50a, 50b) of the aberration correcting lens 17 is configured from a magnet 54 that is adhered to a sidewall of the aberration correcting lens 17 and a noncontact displacement sensor of a hall sensor for use as the Tan displacement sensor 33.

As the aberration correcting lens 17 moves, this lens exhibits tilting and vibration; alternatively, depending upon a position of the aberration correcting lens, tilting of the lens takes place due to its own weight. Additionally in portable-use applications, it becomes a problem that the aberration correcting lens vibrates due to externally applied vibrations and/or shocks.

Upon generation of deviation of the optical axis due to the vibration and/or shock of the aberration correcting lens 17, likewise aberration takes place, resulting in any superior beam spot being no longer obtainable. More seriously, a problem arises as to unwanted offset of the beam spot position on the optical disk 1 by a change in direction of light rays traveling toward the aberration correcting lens 17 due to the presence of the optical axis deviation amount.

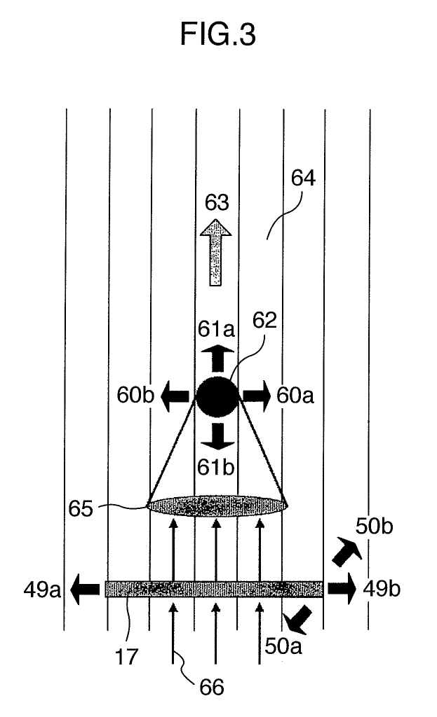

See FIG. 3, which is a diagram showing a top plan view of the aberration correcting lens 17. An explanation will be given of a problem in the case of movement (vibration) in the first displacement direction of the aberration correcting lens 17—here, the directions 49a and 49b—and in the second displacement direction of aberration correcting lens 17—here, the directions 50a and 50b. A laser spot 62 which traces a track 64 on the optical disk is going forward in its traveling direction 63. Parallel light rays 66 from the laser move in the optical axis direction of the aberration correcting lens 17 for execution of aberration correction and then focused into a laser spot on a track 64 with the aid of a convex lens 65 for aberration correction.

For example, upon application of the acceleration to the aberration correcting lens 17 in the direction 49a, the aberration correcting lens 17 moves to the direction 49b. The laser spot 62 moves to the direction 60b in accordance with a moved distance of the aberration correcting lens 17. Although in FIG. 3 the directions 60b and 49b are depicted to be the same direction, these are different directions in many cases in view of the fact that the light path is not linear due to a miniaturized structure of the pickup unit 24. Accordingly, even when the acceleration to be received by the pickup unit 24 is applied to a direction different from the tracking direction (here, the direction along the radius of optical disk 1), off-track takes place in the tracking direction.

There is another, more serious problem. Now, consider a case where the aberration correcting lens 17 is displaced in the second displacement direction (directions 50a and 50b). In this case, consider a scene that the aberration correcting lens 17 goes back and forth in a direction perpendicular to a drawing sheet of FIG. 3. When the acceleration is applied in the direction 50a, the aberration correcting lens 17 changes its position to the direction 50b. The laser spot 62 moves to the direction 61b in accordance with the moved distance of the aberration correcting lens 17. In case the acceleration is applied in a direction opposite to the above-noted direction, the laser spot 62 behaves to move to the direction 61a. If the laser spot moves in a tangential direction of the track 64 in this way, the relative velocity of the laser spot with respect to the optical disk varies, posing a problem as to deterioration of record/playback quality. In the above-noted case, it is at least necessary to employ a scheme for controlling to prevent the recording. In prior known pickup units which are typically for use with DVDs and which do not use the aberration correcting lens 17, the above-noted problem hardly occurs: it is a problem unique to the aberration correcting lens having movable parts or components. In the field of such pickup units which do not use the aberration correcting lens 17, the influence of those accelerations other than the acceleration in the tracking direction has been kept less.

The embodiment of FIG. 1 is arranged to detect movement or acceleration of the aberration correcting lens 17 that is a movable optical unit to be arranged within the pickup unit 24 and perform driving and controlling of the track actuator 4 in a displacement direction opposite to the direction in which the laser spot is displaced by the acceleration to thereby reduce the influence of laser spot offset occurring due to vibrations and/or shocks.

First, an explanation will be given of the tracking servo control.

An amount of off-track (in an inner circumferential direction or in outer circumferential direction) of the laser spot from the track center on an optical disk is detected by the tracking error detector 30. For example, this is to output a voltage (tracking error signal) which is proportional in potential to the off-track amount, and the tracking error signal is input to the tracking servo unit 20. The tracking servo unit amplifies the off-track amount and inputs an actuator drive signal to the driver unit 18 in such a way that the track actuator 4 changes its position in the opposite direction (for example, outer circumference) to the above-noted off-track direction (e.g., inner circumference). The driver unit 18 causes an electrical current to flow in an electromagnetic circuit of the track actuator 4, thereby driving it in the opposite direction to the off-track direction.

An explanation will next be given of the case of displacement, movement or vibration in the first displacement direction of the aberration correcting lens 17 due to external influence factors such as vibrations or shocks, that is, in the radial direction along which the laser spot position on the optical disk changes its position due to displacement of the lens (i.e., the direction in which the laser beam displaces in the tracking direction).

As previously stated, the track actuator does not receive the acceleration at the inner circumference or outer circumference of the disk (to be referred to as the radial direction); however, in case it receives the acceleration in the first displacement direction of the aberration correcting lens 17, the convex lens 5 exhibits displacement in the radial direction. While this displacement results in generation of track offset, the laser spot is position-controlled by the above-noted tracking servo operation so that the spot resides at the track center. Unfortunately, the response frequency of such tracking servo is limited in value. Usually, it has responsibility of from about 3 to 8 KHz. A response delay is also occurrable. Thus, in the case of an excessive shock (e.g., 50 to 300 Hz) or significant acceleration (e.g., 2 to 3 G), it exceeds the limit of the tracking servo control performance. This makes it difficult to achieve the intended position control for causing the laser spot to stay at the track center by sufficiently suppressing the off-track. In view of this, the displacement sensor 26 (acceleration sensor 26) is provided for detecting either the moved distance or the acceleration of the aberration correcting lens 17 in the first displacement direction. The Rad displacement sensor 26 has a mechanism that is movable in parallel with the optical axis direction in sync with the motion of the aberration correcting lens 17 in the optical axis direction, thereby making up an arrangement for reliably detecting only the moved distance in the first displacement direction of the aberration correcting lens 17.

The displacement amount that was detected by Rad displacement sensor 26 is obtained in the form of a voltage value which is proportional to the displacement amount from a base position. This may be realized, for example, in such a way that the position detection is performed by an arrangement having a magnet at movable part of the aberration correcting lens 17 and a hall sensor at stationary part of the pickup unit 24. Alternatively, the position detection may be done by optical means. Similar results to those of this embodiment are also obtainable by use of a sensor of the type detecting the acceleration rather than the displacement mount. The displacement amount detection method and the acceleration detection method are illustrative of the invention and are not to be construed as limiting the invention.

A Rad sensor signal indicative of a displacement of the aberration correcting lens 17 is supplied to the Rad sensor amplifier 16 which performs amplification and coding treatment and inputs the resultant signal to the adder 19. With this signal processing, it is possible to achieve feed-forward control of the track actuator 4 by the displacement amount of the aberration correcting lens 17. As the above-stated tracking servo control is a feedback control method which performs control in response to a result of the off-track, a delay inevitably occurs in the control response. However, with the feed-forward control, there is no such delay problem.

Further, static or “fixed” (DC-like) lens displacement is cogitable, which occurs due to arcuation of the friction guide 13 and parallel guide 32 by the self weight of the aberration correcting lens 17 in a way depending on the moved position in the optical axis direction of the aberration correcting lens 17. For this DC displacement also, it is possible to permit the track actuator 4 to work through the adder 19 to exhibit displacement to cancel each other in the DC manner.

An advantage of this embodiment lies in its ability to reduce or minimize any possible track deviation otherwise occurring due to application of the acceleration in the first displacement direction of the aberration correcting lens 17 even when no acceleration is physically applied to the aberration correcting convex lens 5 with respect to the radial direction in the pickup unit 25 having the aberration correcting lens 17.

An explanation will next be given of the case of displacement, movement or vibration in the second displacement direction of the aberration correcting lens 17 due to external factors such as vibrations or shocks—that is, in the tangential direction along which the laser spot position on the optical disk deviates its position due to displacement of the lens (i.e., the direction in which the laser beam changes its position in a direction along the tangent line of a track). In other words, a coping method on the recording control side will be set forth in regard to a case where the aberration correcting lens 17 is displaced in the direction 50a, 50b of FIG. 3.

Upon application of the acceleration to the aberration correcting lens 17 in the direction 50a, the aberration correcting lens 17 experiences a position change in the direction 50b. The laser spot 62 moves to the direction 61b in accordance with a moved distance of the aberration correcting lens 17. In case the acceleration is applied in the opposite direction to the above-noted direction, the laser spot 62 moves to the direction 61a. This laser spot's movement in the tangential direction of track 64 is a new problematic phenomenon, which has never been occurred in currently available DVD pickup units without the use of the aberration correcting lens 17. Prior known tracking control for controlling the position of a laser spot is designed to employ a process having the steps of detecting an off-track amount relative to a position change in a radial direction and then performing position control by conversion of an electromagnetic wave to force in the radial direction that is opposite to the off-track direction. However, there are no mechanisms for detecting a tracking deviation or offset relative to the tangential direction even when the laser spot position on optical disk is displaced in the tangential direction due to the lens displacement in the way stated supra (i.e., displaced in the direction along which the laser beam changes its position in the track's tangential direction). Accordingly, a change locally occurs in the relative velocity between the laser spot and optical disk. This poses a problem as to a decrease in recording/playback quality. Thus, a need is felt to employ a mechanism for detecting the above-noted state and for providing control to interrupt the recording.

A recording operation will be described with reference to FIG. 1. A laser beam for “burning” recording marks onto a presently loaded optical disk is emitted and output from the laser diode 11. The laser light emission of the laser diode 11 is such that a recording signal as input from the input terminal 28 is passed to the recording processor unit 29, which generates a recording signal for the optical disk 1. This recording signal is sent by the LDD control unit 12 to the laser 11, which emits a recording laser beam, also known as a write beam. This write beam is deflected by the collimate lens 8 into parallel light rays, which are guided to pass through the beam splitter 7 and the aberration correcting lens 17, causing those light rays reflected from the polarizer mirror 6 to be focused by the convex lens 5 onto a recording surface of the optical disk 1. This lens 5 is movably controlled in in-focus and out-focus by focusing servo control (not shown) for far-and-near operations of the distance between it and the disk surface, thereby forming a focussed beam spot on the optical disk. On the other hand, laser light that is reflected from the optical disk travels along the above-stated optical path in the opposite direction to reach the beam splitter 7, which conveys it to the light-receiving unit 10 through the detection lens 9.

The Tan displacement sensor 33 detects, with respect to displacement in the second displacement direction of the aberration correcting lens 17, a displacement amount of the aberration correcting lens 17 in cases where the laser spot on the optical disk deviates in position to the tangential direction. The Tan displacement sensor 33 generates an output signal, which is amplified by the Tan sensor amp 15 and then input to the Tan displacement judgment unit 14. The Tan displacement judgment unit 14 is arranged to perform judgment based on a displacement amount and a displacement amount per unit time. This unit operates in a way which follows: if a position change with its displacement amount of 2 μm or more continues for a time duration of 50 microseconds or greater as an example, this state is determined to be tangential displacement abnormity of the laser spot; then, a recording laser OFF signal is sent to the LDD control unit 12. The LDD controller 12 promptly interrupts the recording laser emission to thereby avoid the occurrence of abnormal recording on the optical disk.

The displacement amount that is detected by the Tan displacement sensor 33 is provided as a voltage value that is proportional to a displacement amount from the base position. This may also be achieved, for example, in such a way that position detection is performed by an arrangement comprising a magnet at movable part of the aberration correcting lens 17 and a hall sensor at part for fixation of the pickup unit 24. Alternatively, the position detection may be done by optical means. Similar results to those of this embodiment are also obtainable by using a sensor which detects the acceleration rather than the displacement mount. The displacement amount detection method and acceleration detection method are illustrative of the invention and are not to be construed as limiting the invention.

The advantage of the illustrative embodiment lies in its ability to rapidly halt a presently executed recording session whenever the displacement occurs in the track tangential direction of the optical disk due to application of vibrations or shocks in the pickup unit 24 having the aberration correcting lens 17, thereby enabling prevention of abnormal data recording on the optical disk.

Alternatively, upon application of the acceleration to the aberration correcting lens 17 in the direction 49a by way of example, the aberration correcting lens 17 moves to the direction 49b. The laser spot 62 moves in the direction 60b in conformity with the moved distance of the aberration correcting lens 17. Although in FIG. 3 the directions 60b and 49a are illustrated to be the same direction, the aberration correcting lens 17 is specifically laid out so that this vector relationship becomes opposite—i.e., the directions are inverse to each other—to ensure that the laser spot exhibits its position change in the direction for mutual canceling of off-track occurring due to the acceleration to be received by the pickup unit 24 in the track direction, thereby making it possible to achieve the intended structure layout with enhanced robustness against shocks and vibrations in the track direction.

It would readily occur to a skilled person in the art that various modifications and alterations are available for the preferred embodiment of the invention as disclosed herein. Consequently, the embodiment disclosed is an exemplary one of this invention and is not to be construed as limiting the invention. The scope of the invention is defined by appended claims, and all possible modifications falling within the coverage of the claims should be interpreted to be involved in the present invention.

It should be further understood by those skilled in the art that although the foregoing description has been made on embodiments of the invention, the invention is not limited thereto and various changes and modifications may be made without departing from the spirit of the invention and the scope of the appended claims.

1. An optical disk device having an optical head unit for recording or reproducing information to or from an optical disk, said device comprising:
a tracking servo unit;
a lens for correction of spherical aberration; and
lens position detection means for detecting a position change amount of said lens while a laser spot position on the optical disk is displaced in a radial direction due to displacement of said lens and for generating a lens position detection result, which is added to an output of said tracking servo unit.

2. An optical disk device having an optical head unit for recording information on an optical disk, said device comprising:
recording control means for recording information on the optical disk;
a tracking servo unit;
a lens for correction of spherical aberration;
lens position detection means for detecting a position deviation amount of said lens with a laser spot position on the optical disk being displaced in a tangential direction due to displacement of said lens; and
judgment means responsive to receipt of a lens position detection result for determining the position deviation amount of said lens, thereby causing said recording control means to interrupt in accordance with a judgment result of said judgment means.

3. An optical disk device having an optical head unit for recording information on an optical disk, comprising:
recording control means for recording information on the optical disk;
a tracking servo unit;
a lens for correction of spherical aberration;
lens position detection means for detecting a position deviation amount of said lens with a laser spot position on the optical disk being displaced in a tangential direction due to displacement of said lens; and
judgment means responsive to receipt of a lens position detection result for determining a position deviation amount per unit time of said lens, thereby interrupting said recording control means in accordance with a judgment result of said judgment means.

4. An optical disk device having an optical head unit for recording or reproducing information to or from an optical disk, comprising:
a tracking servo unit;
a lens for correction of spherical aberration;
lens acceleration detection means for detecting an acceleration of position deviation of said lens with a laser spot position on the optical disk being displaced in a radial direction due to displacement of said lens; and
means for performing negative feedback of a lens acceleration detection result to said tracking servo unit.

5. An optical disk device having an optical head unit for recording information on an optical disk, comprising:
recording control means for recording information on the optical disk;
a tracking servo unit;
a lens for correction of spherical aberration;
lens acceleration detection means for detecting an acceleration of position deviation of said lens with a laser spot position on the optical disk being displaced in a tangential direction due to displacement of said lens; and
judgment means responsive to receipt of a lens acceleration detection result for determining the acceleration of position deviation of said lens, thereby causing said recording control means to halt in accordance with a judgment result of said judgment means.

6. An optical disk device having an optical head unit for writing or reading information to or from an optical disk, comprising:
a tracking servo unit; and
a lens for correction of spherical aberration, wherein
said optical head optically disposes the spherical aberration correcting lens in a vector with a focused light spot of said optical head unit being opposite to an acceleration vector in a radius direction of the optical disk.

7. An optical disk device having an optical head unit for writing or reading information to or from an optical disk, comprising:
a tracking servo unit;
a lens for correction of spherical aberration;
first lens position detection means for detecting a position deviation amount of said lens with a laser spot position on the optical disk being displaced in a radial direction due to displacement of said lens;
adder means for adding a result of the first lens position detection to an output of said tracking servo unit;
second lens position detection means for detecting a position deviation amount of said lens with the laser spot position on the optical disk being displaced in a tangential direction due to displacement of said lens; and
judgment means responsive to receipt of a result of the second lens position detection for determining the position deviation amount of said lens, thereby deactivating said recording control means in conformity to a judgment result of said judgment means.
